(19) United States
(12) Patent Application Publication
(10) Pub. No.: US 2009/0125519 A1
(43) Pub. Date: May 14, 2009

(54) Device, system, and method for regulating software lock elision mechanisms

(75) Inventors: Arch D. Robison, Champaign, IL (US); Paul M. Petersen, Champaign, IL (US)

Correspondence Address: PEARL COHEN ZEDEK LATZER, LLP, 1500 BROADWAY, 12TH FLOOR, NEW YORK, NY, 10036, US

(73) Assignee: Intel Corporation

(21) Appl. No.: 11/984,002

(22) Filed: Nov. 13, 2007

(51) Int. Cl. G06F 7/00

(52) U.S. Cl. 707/8

(57) ABSTRACT

A method, apparatus and system for, in a computing apparatus, comparing a measure of data contention for a group of operations protected by a lock to a predetermined threshold for data contention, and comparing a measure of lock contention for the group of operations to a predetermined threshold for lock contention, eliding the lock for concurrently executing two or more of the operations of the group using two or more threads when the measure of data contention is approximately less than or equal to the predetermined threshold for data contention and the measure of lock contention is approximately greater than or equal to a predetermined threshold for lock contention, and acquiring the lock for executing two or more of the of operations of the group in a serialized manner when the measure of data contention is approximately greater than or equal to the predetermined threshold for data contention and the measure of lock contention is approximately less than or equal to a predetermined threshold for lock contention. Other embodiments are described and claimed.

### BACKGROUND OF THE INVENTION

In multithreaded programs, synchronization mechanisms such as semaphores or locks, may be used, for example, to enable one or more selected threads to have exclusive access to shared data for a specific, predetermined, or critical section of code. The selected threads may acquire the lock, execute the critical section of code, and release the lock. Other, for example, non-selected threads, may wait for the lock until the selected threads have completed accessing or using the critical section of code. Such mechanisms may order or serialize access to the code.

Micro-architectural techniques, such as, speculative lock elision (SLE), may be used, for example, to circumvent, deactivate, remove, ignore, or disregard dynamically unnecessary lock-induced serialization and may, for example, enable highly concurrent multithreaded execution of critical and/or locked sections of code, without the use of locks. For example, SLE may execute multiple threads concurrently by using cache resident transactional memory (CRTM) to execute the group of selected threads. When successful speculative elision is validated, multithreaded programs may be concurrently executed without acquiring a lock.

Errors or misspeculation, for example, due to inter-thread data conflicts or contention, may be detected, for example, using cache, for example, CRTM, mechanisms. When substantial errors in speculation occur, a rollback mechanism may be used for recovery. For example, the transaction may be retried, or a lock may be obtained.

Although the SLE may decrease the time for executing multithreaded processes, in some cases, the SLE may increase the time for executing multithreaded processes, for example, as compared with executing serialized processes by acquiring uncontended locks. Thus, in some cases using SLE instead of acquiring locks may decrease computational efficiency.

A need exists for optimizing speed and performance for multitlireaded processes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system according to an embodiment of the present invention;

FIG. 2 is a diagram showing the response of an SLE regulator to varying levels of data and/or lock contention according to an embodiment;

FIG. 3 is a flow chart of a response mechanism of the SLE regulator for regulating a SLE mechanism according to an embodiment of the present invention;

FIG. 4 is schematic illustration of a mechanism for updating cache memory to reduce cache line contention according to an embodiment of the present invention;

FIG. 5 includes pseudo-code according to an embodiment of the present invention;

FIG. 6 includes pseudo-code according to an embodiment of the present invention;

FIGS. 7A and 7B include pseudo-code according to an embodiment of the present invention; and

FIG. 8 is a table showing the response of the SLE regulator to varying levels of data and/or lock contention according to an embodiment of the present invention.

It will be appreciated that for simplicity and clarity of illustration, elements shown in the drawings have not necessarily been drawn accurately or to scale. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device or apparatus, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Although the present invention is not limited in this respect, the circuits and techniques disclosed herein may be used a variety of apparatuses and applications such as personal computers (PCs), stations of a radio system, wireless communication system, digital communication system, satellite communication system, and the like.

Embodiments of the invention may provide a method, and system for, in a computing apparatus, comparing a measure of data conflict or contention and lock conflict or contention for a group of operations protected by a lock to a predetermined threshold for data contention and a predetermined threshold for lock contention, respectively, eliding the lock for concurrently executing a plurality of operations of the group using a plurality of threads when the measure of data contention is less than or equal to the predetermined threshold for data contention and the measure of lock contention is greater than or equal to a predetermined threshold for lock contention, and acquiring the lock for executing a plurality of operations of the group in a serialized manner when the measure of data contention is greater than or equal to the predetermined threshold for data contention and the measure of lock contention is less than or equal to a predetermined threshold for lock contention. Embodiments of the invention may be implemented in software (e.g., an operating system or virtual machine monitor), hardware (e.g., using a processor or controller executing firmware or software, or a cache or memory controller), or any combination thereof, such as controllers or CPUs and cache or memory.

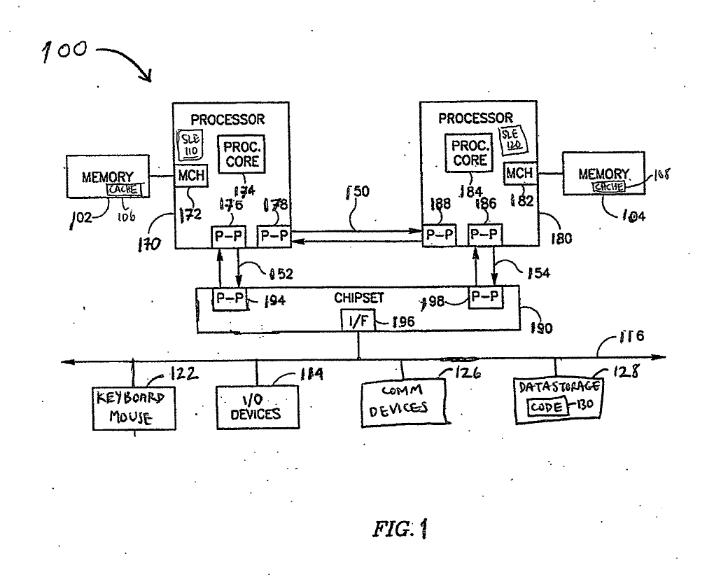

Reference is made to FIG. 1, which schematically illustrates a computing system 100 according to an embodiment of the present invention. It will be appreciated by those skilled in the art that the simplified components schematically illustrated in FIG. 1 are intended for demonstration purposes only, and that other components may be used.

System 100 may include, for example, SLE devices 110 and 120 for implementing the SLE mechanism in each of processors 170 and 180, respectively. SLE devices 110 and 120 may be independent components or integrated into processors 170 and 180, respectively, and/or code 130. In some embodiments, the SLE mechanism may be implemented using hardware support for multithreaded software, in the form of for example shared memory multiprocessors or hardware multithreaded architectures. In some embodiments, the SLE mechanism may be implemented using microarchitecture elements, for example, without instruction set support and/or system hardware modifications. In other embodiments, implementing the SLE mechanism may include hardware multithreaded architectures and/or multithreaded programming.

System 100 may include, for example, a point-to-point busing scheme having one or more controllers or processors, e.g., processors 170 and 180; memories, e.g., memories 102 and 104 which may be internal or external to processors 170 and 180, and may be shared, integrated, and/or separate; and/or input/output (I/O) devices, e.g., devices 114, interconnected by one or more point-to-point interfaces. Processors 170 and 180 may include, for example, a central processing unit (CPU), a digital signal processor (DSP), a microprocessor, a host processor, a plurality of processors, a controller, a chip, a microchip, or any other suitable multi-purpose or specific processor or controller. Memories 102 and 104 may include for example cache memory 106 and 108, respectively, (e.g., CRTM cache memory), such as, dynamic RAM (DRAM) or static RAM (SRAM), or may be other types of memories. Processors 170 and/or 180 may include processor cores 174 and 184, respectively. Processor cores 174 and/or 184 may include a one or more storage units 105, processor pipeline(s) 118, and any other suitable elements for executing multithreaded, parallel, or synchronized processes, programs, applications, hardware, or mechanisms. Processor execution pipeline(s) 118 which may include, for example, fetch, decode, execute and retire mechanisms. Other pipeline components or mechanisms may be used.

According to some embodiments of the invention, processors 170 and 180 may also include respective local memory channel hubs (MCH) 172 and 182, e.g. to connect with memories 102 and 104, respectively. Processors 170 and 180 may exchange data via a point-to-point interface 150, e.g., using point-to-point interface circuits 178, 188, respectively. Processors 170 and/or 180 may exchange data with a chipset 190 via point-to-point interfaces 152, 154, e.g., using point to point interface circuits 176, 194, 186, and 198. Chipset 190 may also exchange data with a bus 116 via a bus interface 196.

Although the invention is not limited in this respect, chipset 190 may include one more motherboard chips, for example, an Intel® “north bridge” chipset, and an Intel® “south bridge” chipset, and/or a “firmware hub”, or other chips or chipsets. Chipset 190 may include connection points for additional buses and/or devices of computing system 100.

Bus 116, may include, for example, a “front side bus” (FSB), a small computer system interface (SCSI) bus, an integrated drive electronics (IDE) bus, or a universal serial bus (USB) bus, e.g., as are known in the art. For example, bus 116 may connect between processors 170 and/or 180 and a chipset (CS) 190. For example, bus 116 may be a CPU data bus able to carry information between processors 170 and/or 180, I/O devices 114, a keyboard and/or a cursor control devices 122, e.g., a mouse, communications devices 126, e.g., including modems and/or network interfaces, and/or data storage devices 128, e.g., to store software code 130, and other devices of computing system 100. In some embodiments, data storage devices 128 may include a fixed magnetic disk, a floppy disk drive, an optical disk drive, a magneto-optical disk drive, a magnetic tape, or non-volatile memory including flash memory.

In some embodiments, multi-thread processes (e.g., prograns, applications, algorithms, etc.) may include a group or set of operations that may be executed atomically. The group of operations may be protected, for example, using a semaphore or lock.

Embodiments of the invention may provide a system and method for regulating the SLE mechanisms (e.g., which may be referred to as a “SLE regulator”). The SLE mechanism may be selectively applied for executing multithreaded processes, for example, based on a degree of lock contention and/or a degree of data contention. In one embodiment, the SLE regulator may determine and/or apply a computationally advantageous mechanism (e.g., with respect to the duration of execution, the complexity of steps, etc.) for executing a locked group of operations. For example, an execution mechanism may be selected from one of a SLE mechanism for concurrently executing a locked group of operations, a lock mechanism for executing a locked group of operations in a serialized manner, and/or alternate and/or additional execution mechanisms.

In some embodiments, a lock mechanism may execute the group of operations in a serialized, sequential, ordered, successive, and/or consecutive manner. A specific thread of a multi-thread process may access the locked group of operations for executing the group of operations during substantially any period or interval of time. Typically, other threads do not have access to the locked group of operations and may execute the group of operations at substantially a different time. Thus, the automated execution of the group of operations by a lock mechanism may be serialized.

In other embodiments, SLE mechanisms may be used for executing a locked group of operations by multiple threads, for example, without acquiring the semaphore or lock for substantially concurrently executing each of the operations of the group. For example, the SLE mechanism may for example elide the lock. Elision of a semaphore or lock may be implemented using, for example, a SLE mechanism. Eliding a semaphore or lock may include, for example, omitting the acquiring of the semaphore or lock. Eliding a semaphore or lock may include, for example, circumventing, deactivating, removing, ignoring, or disregarding the semaphore or lock and/or, for example, lock-induced serialization. Eliding a semaphore or lock may, for example, enable highly concurrent multithreaded execution of critical, protected and/or locked sections of codes or operations, for example, without acquiring or using the locks or semaphore. In some embodiments, the SLE mechanism may, for example, use cache memory, such as CRTM, to execute the locked group of operations by multiple threads concurrently or during substantially overlapping periods of time.

In some embodiments, the cache memory, such as CRTM, may detect data contention, for example, when two or more processes or transactions make conflicting or concurrent attempts to access, use or retrieve substantially the same or overlapping data. For example, the cache memory, may detect when two or more process or threads attempt to execute two locked groups of substantially overlapping data. In one embodiment, when cache memory detects such contention the process may, for example, hold, stall, retry, and/or abort. In one embodiment, the cache memory may detect such contention when, for example, two or more threads or processes attempt to access the same memory location at substantially the same or overlapping times and, for example, one of the threads or processes attempts to modify the memory location. In some embodiments, the cache memory may detect data contention on a more global scale. For example, data contention may be detected for data corresponding to a group of memory locations (e.g., a cache line) by treating a group or multiple locations (e.g., the cache line) as a single location (e.g., for the purpose of conflict detection). In some embodiments, when the cache memory detects a substantial overlap in the data accessed by two or more threads or processes, one or more of the threads or processes may be modified, for example, aborted.

The SLE regulator and the SLE mechanism, thereof, may be substantially integrated, hidden, automated, and/or translucent, to related multithreaded programming and may optimizing speed and performance for the processes thereof.

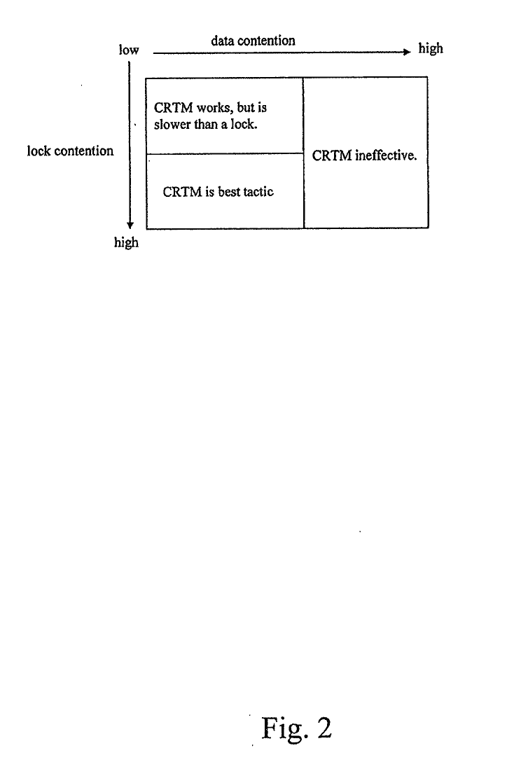

Reference is made to FIG. 2, which is a diagram depicting a relationship between semaphore or lock and/or data contention according to an embodiment of the present invention.

In some embodiments, SLE mechanisms may be ineffective or computationally expensive, for example, when a conflict, for example, of data contention, lock contention, or a combination thereof is encountered. For example, data contention may occur when each of a first and a second locked group of operations have overlapping data. In such embodiments, the concurrent execution (e.g., by the SLE mechanism) of each of the first and a second locked group of overlapping operations may, for example, interfere with or break the cohesion of one or both of the groups. For example, lock contention may occur when a plurality of threads contend to execute substantially the same critical section of code. Data contention may occur when a plurality of threads contend to access the same or overlapping data, and, for example, one or more threads attempt to modify the data. For example, two threads that contend to execute substantially the same critical section of code and act on substantially disjoint, disparate, or non-overlapping data, may have lock contention and not data contention.

A measure of lock contention may include a percentage of locking attempts that are contended. For example, a measure of lock contention may be, for example, 75%, when for example, for every four threads that attempt to acquire the lock, three threads wait for another thread to release the lock. A measure of data contention may include a percentage of the conflict of accessing data to execute critical sections of code. For example, a measure of data contention may be, for example, 80%, when for example, for every five threads that attempt to execute a critical section of code, four threads encounter data contention. Other measures or methods of measuring may be used. Data and/or lock contention may be detected, for example, using cache memory, for example, CRTM. In various embodiments, data contention and/or lock contention may occur to varying degrees.

In one embodiment, when the CRTM detects a conflict to concurrently executing the first locked group, for example, a conflicting concurrent execution of a second locked group, the SLE mechanisms may retry the concurrent execution of the first locked group. In another embodiment, when the CRTM may detect such a conflict (e.g., data and/or lock contention) and a lock mechanism may be used to execute the group of operations in a serialized manner.

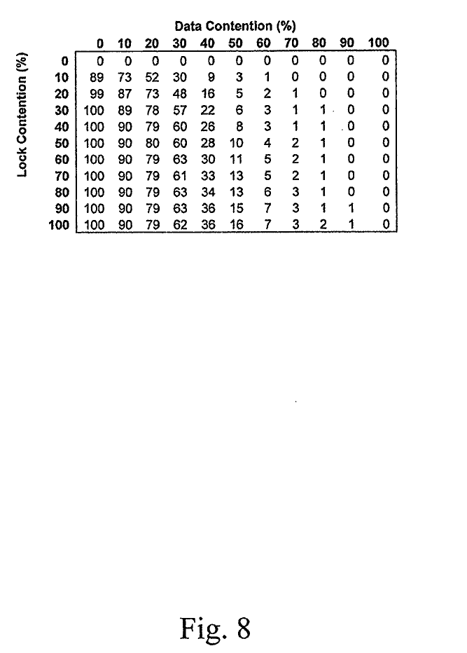

In some embodiments, the SLE regulator may determine whether to use the SLE mechanism or, for example, a lock mechanism, for example, based, on a measure of data contention and/or lock contention of the group of operations (e.g., with other groups of operations). For example, the SLE regulator may set (e.g., predetermined or dynamic) threshold values and/or ranges for lock and data contention for determining whether and with what frequency or probability to execute each of the SLE mechanism and lock mechanisms. For example, in one embodiment, the SLE regulator may determine to execute the SLE mechanism (e.g., predominantly) when the data contention for the locked group of operations is substantially minimal (e.g., below the threshold value of approximately 20%) and the lock contention is substantially maximal (above the threshold value of approximately 30%). Likewise, the SLE regulator may determine to execute the lock mechanism predominantly when the data contention for the locked group of operations is substantially maximal (e.g., above the threshold value of approximately 20%) or the lock contention is substantially minimal (below the threshold value of approximately 30%). Other numerical examples of the predetermined thresholds are depicted in FIG. 8. In some embodiments, the predetermined threshold for lock and/or data contention, and the frequency of using the lock and/or SLE mechanisms may occur on a continuous scale, for example, of varying degrees or percentages. For example, the table in FIG. 8 shows that when lock and data contention occur 50% of the time for the group of operations, the SLE regulator recommends using the SLE mechanism 10% of the time and the lock mechanism 90% of the time.

In one embodiment, the SLE regulator, for example, using the SLE device, may compare a measure of data contention and lock contention for a group of operations protected by a lock to predetermined thresholds for data and lock contention, respectively. The processor may elide the lock for concurrently executing two or more operations of the group using two or more threads when the measure of data contention is less than or equal to the predetermined threshold for data contention and the measure of lock contention is greater than or equal to a predetermined threshold for lock contention and may acquire the lock, for example, for deactivating the lock, for executing two or more operations of the group in a serialized manner when the measure of data contention is greater than or equal to the predetermined threshold for data contention and the measure of lock contention is less than or equal to a predetermined threshold for lock contention. In some embodiments, the predetermined thresholds for data contention and lock contention for a group may include a measure of whether and to what degree data contention and lock contention was detected between the group and another group during a past execution of the group. The measure may be stored as a counter value in for example cache memory 106 and/or 108.

Cache memory 106 and/or 108 (e.g., CRTM) may store or record the measure of data contention as a first global variable, which may be referred to as “CrtmMeter” and the measure of lock contention as a second global variable, which may be referred to as “LockMeter”. Other terms may be used. Each of the first and second global variables may be stored in cache memory 106 and/or 108, for example, in one or more predetermined fields. For example, one or more CrtmMeter and/or LockMeter values may be stored in cache memory 106 and/or 108 for each group of operations, tracking a history or past record of data contention and lock contention measurements detected between the group and another group.

In some embodiments, a positive value for a CrtmMeter and LockMeter may indicate that applying the corresponding mechanism, for example, the SLE mechanism and the lock mechanism, respectively, has, according to a weighted average, succeeded in past executions for a group of data. For example, a negative value may indicate that the applying the corresponding mechanism has, according to a weighted average, failed in past executions for a group of data.

In some embodiments, when the CRTM detects data contention, the CrtmMeter may indicate a negative, “lose”, or other measure, value, or field, indicating that using the SLE mechanism may have been undesirable or computationally inefficient. For example, when the CRTM does not detect data contention, the CrtmMeter may indicate a positive, non-negative, “win”, or other measure, value, or field, indicating that using the SLE mechanism may have been desirable or computationally beneficial. The CrtmMeter and LockMeter global variables and/or symbols, such as, “wins” and “loses” may, for example, be stored in CRTM 106 and/or 108.

In some embodiments, the SLE regulator may compare the CrtmMeter and LockMeter global variables for a group of operations (e.g., protected by a lock) to one or more predetermined threshold for determining whether to use the SLE mechanism (e.g., to elide the lock) or the lock mechanism. In one embodiment, the predetermined threshold may for example be zero. If the LockMeter is negative or less than the predetermined threshold (e.g., in the recorded past, applying the lock mechanism may have been a losing tactic) and the CrtmMeter is non-negative or greater than the predetermined threshold (e.g., in the recorded past, applying the SLE mechanism may have been a wining tactic). The current result, for example, if data contention or lock contention was detected between the group and another group during the current or latest execution of the group, may be fed back into the regulator, for example, stored in cache memory 106 and/or 108.

In some embodiments, each of the CrtmMeter and LockMeter may be stored as global variables may include a measure or weighted average (e.g., an exponentially decaying average) that may record a result of an execution mechanism, for example, if a SLE regulator detects data contention and/or lock contention for a group of locked data. The meters may exponentially decay, for example, so that older information may be devalued relative to newer information.

In some embodiments, when a group is locked with an uncontended lock, a CrtmMeter may indicate a “win” since there is typically no data or lock contention. However, in embodiments when a group is locked with an uncontended lock, the lock mechanism may execute the group relatively faster than the SLE mechanism. In such embodiments, the SLE regulator may override executing a group of operations using the SLE mechanism (e.g., regardless of the CrtmMeter and LockMeter values) and execute the lock mechanism instead.

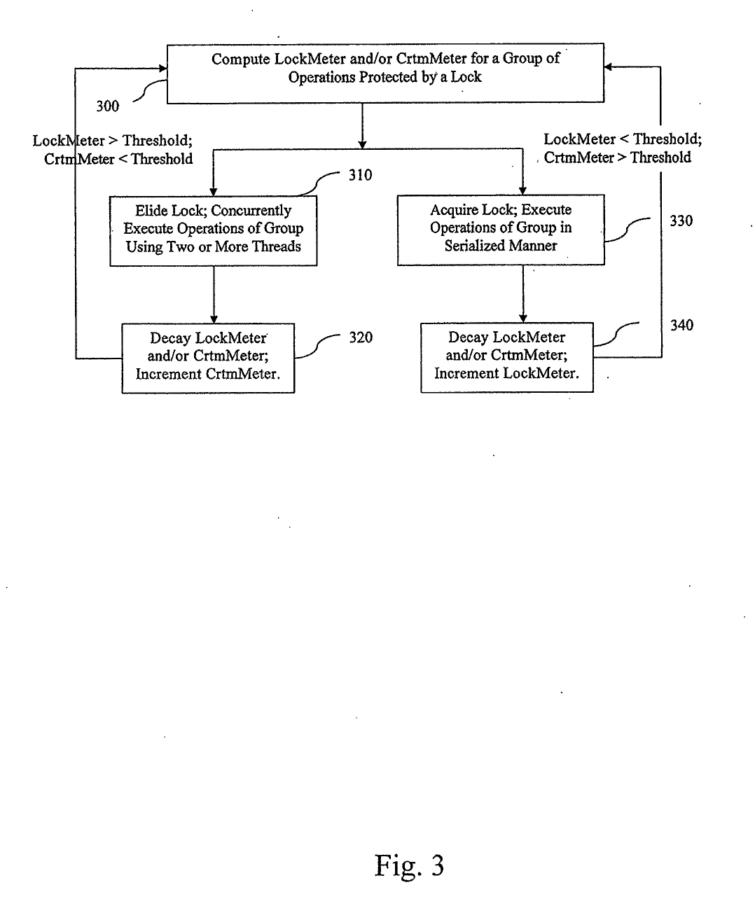

Reference is made to FIG. 3, which is a flow chart of a response mechanism of the SLE regulator for regulating a SLE mechanism according to an embodiment of the present invention.

In operation 300, a processor may compare, compute, determine, read, and/or retrieve a measure of data contention and semaphore or lock contention for a group of operations protected by a semaphore or lock to predetermined thresholds for data and lock contention, respectively. In one embodiment, the measure may be recorded as a “LockMeter” and/or a “CrtmMeter”, for example, measuring a degree of lock conflict or contention and data conflict or contention, respectively. The processor may determine if the measure, for example, the LockMeter and CrtmMeter, are substantially high and low, respectively. In one embodiment, the measure of data contention and lock contention may be detected during a past execution of the group.

Predetermined thresholds for lock and or data contention indicating a degree of lock contention and data contention, respectively, may be determined and/or computed. In one embodiment, the predetermined thresholds for data and lock contention include measures of data and lock contention, respectively, for the group of operations detected during a past execution of the group.

For example, predetermined threshold for data contention and lock contention may be approximately 20% and 30%, respectively, which may indicate that approximately 20% and 30% of the iterations of the operations encountered data and locks that may be contended by other groups, respectively. Other value ranges or thresholds may be used.

In some embodiments, the LockMeter and/or CrtmMeter may be stored in cache memory, for example, as global variables. For example, the LockMeter and/or CrtmMeter may be stored and/or recorded as exponentially decaying counter values. The LockMeter and/or CrtmMeter are described in further detail herein.

If the measure of lock contention (e.g., LockMeter) is substantially high (e.g., greater than or equal to the predetermined threshold for lock contention) and the measure of data contention (e.g., CrtmMeter) is substantially low (e.g., less than or equal to the predetermined threshold for data contention), a process may proceed to operation 310.

If the measure of lock contention (e.g., LockMeter) is substantially low (e.g., less than or equal to the predetermined threshold for lock contention) and the measure of data contention (e.g., CrtmMeter) is substantially high (e.g., greater than or equal to the predetermined threshold for data contention), a process may proceed to operation 330.

In operation 310, a processor may elide the lock for concurrently executing a plurality of operations of the group using two or more threads, for example, to access CRTM. In one embodiment, an SLE mechanism may be used. The processor may execute the plurality or group of operations.

In operation 320, a processor may decay the measure of data contention and lock contention, for example, the CrtmMeter and/or LockMeter, respectively. In some embodiments, decaying the measure of data contention and lock contention may be accomplished, for example, by updating or replacing the measure, for example, with a fraction of the original measure value (e.g., updating a measure with 15/16 of the measure.) In one embodiment, the processor may increase or increment the measure of data contention, for example, the CrtmMeter (e.g., by one (1)).

In operation 330, a processor may acquire the lock protecting the group of operations and may execute the operations, for example, in a serialized manner. In one embodiment, the processor may choose an appropriate lock, for example, held by one or more specific threads. The processor may execute the plurality or group of operations.

In operation 340, a processor may decay the measure of data contention and lock contention, for example, the CrtmMeter and/or LockMeter, respectively. In one embodiment, the processor may increase or increment the measure of lock contention, for example, the LockMeter (e.g., by one (1)).

In some embodiments, if a process completes either of operations 320 or 340, the process may return to operation 300 to re-evaluate the measure, for example, of the LockMeter and CrtmMeter, for continuing the execution of the group of operations by other or additional one or more threads.

The processor may periodically override the comparison of the measure of data contention and/or lock contention with the predetermined thresholds, acquire the semaphore or lock, and execute the plurality of operations of the group, for example, in a serialized manner. In another embodiment, the processor may periodically override the comparison, elide the lock, and concurrently execute the plurality of operations.

Other operations or series of operations may be used.

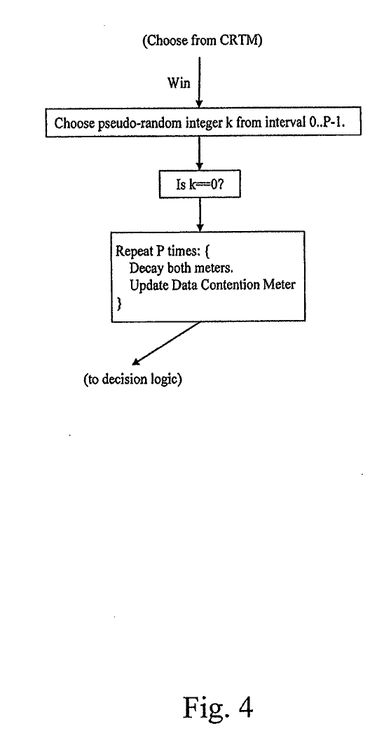

Reference is made to FIG. 4, which schematically illustrates a mechanism for updating cache memory (e.g., cache memory 106 and/or 108, such as, CRTM) to reduce cache line contention according to an embodiment of the present invention. In some embodiments, when the SLE regulator applies the SLE mechanism and there is a “win”, cache lines may remain unchanged between cores and, for example, there may be no need to update or transfer data in the cache lines of cache memory 106 and/or 108. However, in such embodiments, meters, for example, the CrtmMeter and the LockMeter, may change, which may result in cache line contention. Cache line contention may occur, for example, when two or more threads attempt to access a cache line substantially simultaneously and, for example, one or more of the threads attempts to modify the cache line. In one embodiment, to avoid such cache line contention, the CrtmMeter and the LockMeter, may be updated, for example, probabilistically. For example, when there are a number of cores, p, the meters may be updated, for example, once time for every execution of the p cores (e.g., 1/pth of the time that there may be a new result for the meters). In such embodiments, when there is an update, the update may be reiterated, for example, p times. In some embodiments, such updating mechanisms may provide approximately the same results as updating the meter during substantially every execution of a core. However, since in such updating mechanisms, a thread may update the meter p times using data from a local copy, such updating mechanisms may cumulatively provide relatively less cache line contention than when a thread updates the meter p times, accessing information, for example, from the CRTM.

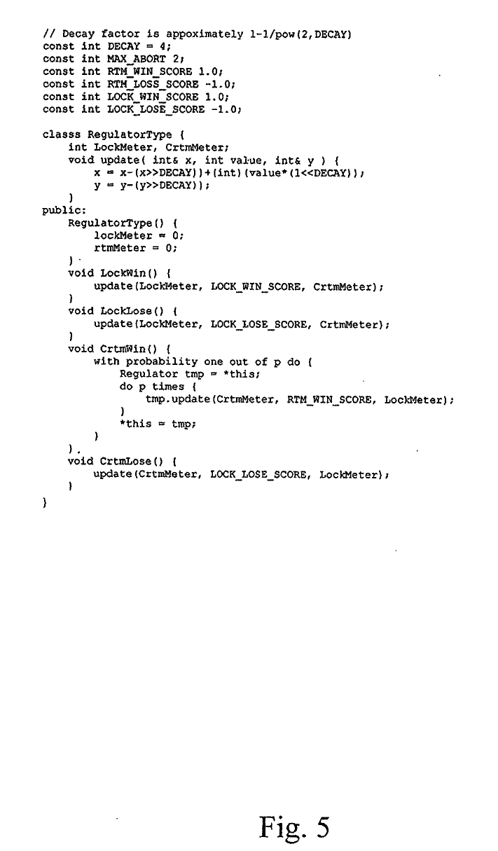

Reference is made to FIG. 5, which is pseudo-code for recorded results of using the SLE and lock mechanisms, for example, using exponentially decaying counters, according to an embodiment of the present invention. Operations including, for example, “Constructor Regulator” may initialize the SLE regulator. Operations including, for example, “LockWin” and “CrtmWin” may enter a win entry for the LockMeter and the CrtmMeter, respectively. Operations including, for example, “LockLose” and “CrtmLose” may enter a lose entry for the LockMeter and the CrtmMeter, respectively. Operations including, for example, “BetOnCrtm”, may enter a “true” entry for recommending the SLE mechanism for the next execution of a locked group of operations.

In one embodiment, when a test results in, for example, CrtmMeter>0 instead of CrtmMeter?0, the SLE regulator may be stuck on, for example, a “BetOnLock” operation, since typically the meter does not initially recommend the SLE mechanism and thus, will not record CrtmWins, which may be required for using the SLE mechanism in the future. In another embodiment, a test results in, for example, LockMeter<0 instead of LockMeter?0, the SLE regulator may occasionally use the lock mechanism instead of the SLE mechanism, for example, when the LockMeter decays (e.g., to zero). Such embodiments may include periodically using the lock mechanism regardless of the meter values, for example, in case the lock has become uncontended (e.g., which may occur during program behavior changes over time). In such embodiments, occasionally or periodically applying the lock mechanism may be used for determining when there may be an advantage in using the SLE mechanism.

In some embodiments, the SLE mechanism may provide undesirable results for a variety of reasons, for example, including context switches by an operating system. In a context switch, the operating system may suspend a thread and, for example, use the (e.g., hardware) resources that were used to run the thread. For example, in some embodiments, when a context switch occurs, the SLE mechanism may execute a roll back mechanism. In some embodiments, the SLE mechanism may be reiterated, for example, used twice, for executing a particular group of operations, for example, before the SLE mechanism may be determined to have failed and the lock mechanism may be applied.

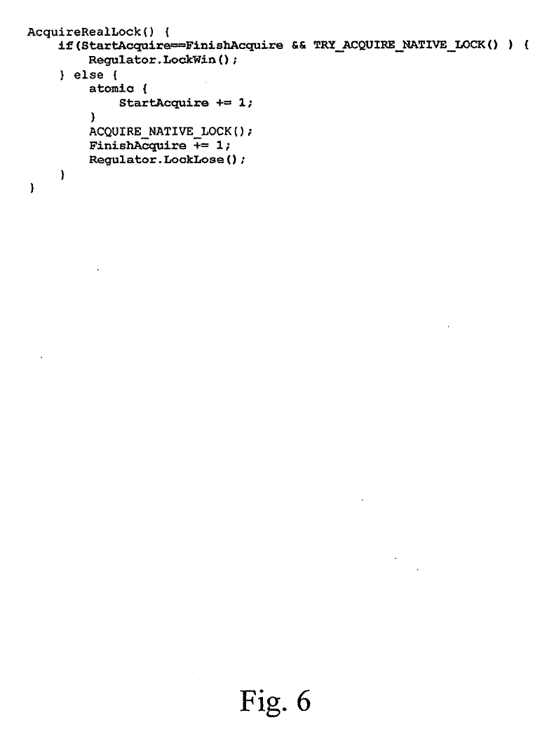

Reference is made to FIG. 6, which is pseudo-code for acquiring an underlying native lock and determining if the native lock is contended, according to an embodiment of the present invention. In some embodiments, an operation, for example, “ACQUIRE_NATIVE_LOCK”, may be used to acquire an underlying native lock, and an operation, for example, “RELEASE_NATIVE_LOCK”, may be used to release an underlying native lock. A “native lock” may include, for example, a lock or semaphores that may be difficult or undesirable to elide. In some embodiments, a group of operations protected by a native lock may be executed using a serialized process. In some embodiments, an operation, for example, “TRY_ACQUIRE_NATIVE_LOCK”, may acquire an underlying native lock when the lock is available and may return a “false” entry substantially immediately when the lock is held, being used or unavailable. The operation may, for example, stop attempts to acquire the lock instead of waiting for the lock to become available. In some embodiments, for example, when the SLE mechanism is a recursive mechanism, the native lock may be recursively defined. The native lock may be defined by other or alternate means.

In some embodiments, an operation, for example, “AcquireRealLock”, may use, for example, global counters, such as, “StartAcquire” and “FinishAcquire”. For example, StartAcquire and FinishAcquire may count the number of threads that may start executing the ACQUIRE_NATIVE_LOCK operation and finish executing the ACQUIRE_NATIVE_LOCK operation, respectively. A substantial difference in the StartAcquire and FinishAcquire counters may indicate that there may be threads waiting to acquire a native lock. In some embodiments, each of two or more thread concurrently executing a group of operations typically do not re-execute the group of operations until the StartAcquire and FinishAcquire counters may be substantially similar. Thus a thread, which acquires and releases the lock may not re-execute the group of operations (e.g., execute the TRY_ACQUIRE_NATIVE_LOCK operation), for example, until the other threads have completed attempts for acquiring the lock.

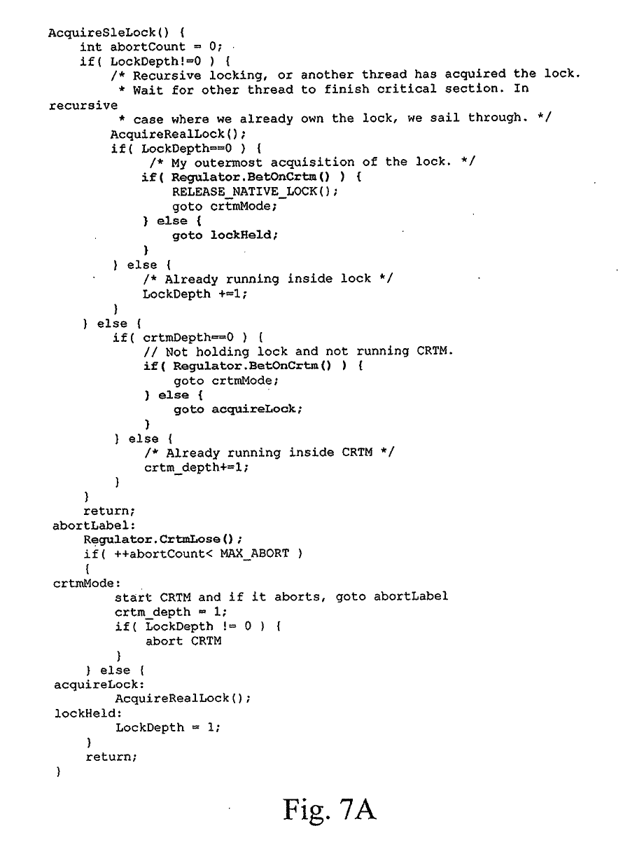

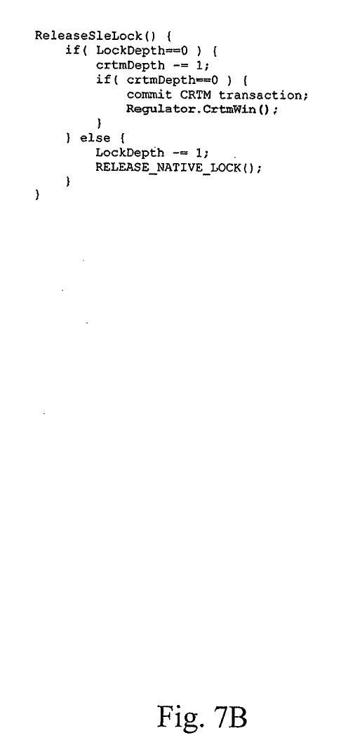

Reference is made to FIG. 7A, which is pseudo-code for acquiring a SLE lock for executing a locked group of operations according to an embodiment of the present invention. An operation, for example, the variable “abortCount”, may count an integer number of times the SLE mechanism has aborted or failed to execute a locked group of operations, for example, during past executions. The SLE mechanism may count an operation as aborted or failed, when, for example, data conflict is detected. In some embodiments, a global variable, for example, “LockDepth” may track or record, for example, a nesting depth at which the lock protecting the group of operations has been acquired. The nesting depth of the lock may include, for example, a net number of times the lock may have been acquired in past processes, minus a number of times the lock may have been released in past processes. The nesting depth may exceed one, for example, when the lock is recursively acquired, for example, when the lock is acquired after the lock was acquired by the same thread and, for example, not yet released. Such embodiments may support recursively acquired SLE locks.

In some embodiments, for example, when a global variable, for example, LockDepth, initially has a nonzero value, the lock may be inaccessible to a first thread since the lock may be, for example, previously acquired by the first thread or by another thread. In some embodiments, the LockDepth value may be used to determine whether the lock was acquired by the first thread or another thread. For example, the first thread may attempt to acquire the native lock and the resulting value of LockDepth may be evaluated. For example, if the resulting value of LockDepth is approximately zero the SLE regulator may determine whether to elide the lock for executing the SLE mechanism or for example, hold the lock for executing the lock mechanism. For example, if the LockDepth initially has a LockDepth value of approximately zero, a thread-local variable, for example, “crtmDepth” may be evaluated. If crtmDepth is approximately zero, then the SLE regulator may determine whether to execute the SLE mechanism or the lock mechanism. If crtmDepth is nonzero, the CRTM nesting level, for example, abortcount, may be incremented, for example, by one. In one embodiment, the SLE regulator may be notified when the SLE mechanism aborts or fails to execute the locked group of operations using, for example, an “abortLabel”.

FIG. 7B includes pseudo-code for releasing a SLE lock for executing a locked group of operations according to an embodiment of the present invention. In some embodiments, the SLE regulator may evaluate or read a global variable, for example, LockDepth, to determine whether the lock was elided and the SLE mechanism was executed. For example, if the LockDepth is approximately zero, then the lock was elided. In one embodiment, when the LockDepth is approximately zero, a thread-local variable, for example, crtmDepth, may be decremented (e.g., by one (1)). For example, if the decremented LockDepth is approximately zero, a process may execute the SLE mechanism and a CrtmWin may be recorded. For example, when the LockDepth is nonzero (e.g., indicating the lock has be acquired) the lock may be released.

The pseudo-code depicted in FIGS. 5-7B may include code written in for example the C++ language. Other code or computer languages may be used.

Reference is made to FIG. 8, a table showing the response of the SLE regulator to varying levels of data and/or lock contention according to one embodiment. The table shows recommended percentages that may be statistically generated by an SLE regulator for determining whether or not to use an SLE mechanism, for example, based on lock and data contention. For example, the values depicted in the table may result from an exemplary simulation, where lock and data contention values (e.g., generated randomly) were input into the SLE regulator process, which as a result outputted recommended percentages of SLE acquisitions. These values are a demonstration of one embodiment. Other values, percentages, and/or ratios may be used. For example, the table shows that when lock and data contention occur 50% of the time (e.g., when executing groups of operations), the SLE regulator recommends using the SLE mechanism 10% of the time (e.g., for executing 10% of the groups of operations). For example, when lock and data contention occur 50% of the time, the SLE regulator recommends using the lock mechanism 90% of the time (e.g., for executing 90% of the groups of operations).

The table depicted in FIG. 8 may, according to one embodiment, reflect a discrete version of the information depicted in the diagram of FIG. 2.

An SLE regulator may recommend using the SLE mechanism when there are high degrees of data and/or lock contention. The SLE regulator may occasionally implement the SLE mechanism, regardless of levels of data and/or lock contention, for example, to determine if the SLE mechanism may be effective (e.g., if program behavior changes to decrease contention).

In some embodiments, the SLE mechanism may be used for implementing transactional memory (TM). For example, there may be a global SLE lock that may protect transactions for groups of operations (e.g., execution). In order to execute the group of operations, a thread may hold the global SLE lock during execution. In one embodiment, using the SLE mechanism may enable multiple threads to execute the group of operations concurrently, for example, by eliding the global SLE lock. A copy of the SLE regulator state may be provided for each lexically distinct transaction or execution by a thread. For example, the SLE regulator state may be associated with or implemented in, for example, a first source line of each transaction.

In one embodiment, when an SLE mechanism is used for implementing TM, a thread may record information associated with, for example, each read or write to thread shared memory, for example, to support user requested aborts or retries of a transaction. When there is a substantially large number of such barriers in a transaction (e.g., if the number of reads and writes exceeds a predetermined threshold), an SLE regulator may recommend (e.g., for computational efficiency) using the SLE mechanism instead of the lock mechanism (e.g., even when the lock is not contended). A meter reading, for example, LockLose, may be recorded for transactions having such extensive barriers. Such transactions may be executed using the lock mechanism.

A SLE regulator may predict, for example, based on past executions, whether to use an SLE mechanism for executing a locked group of operations by multiple threads concurrently or the lock mechanism for executing the locked group of operations in a serialized manner. An SLE regulator may record a history of both lock contention and data contention, for example, using exponentially decaying counters.

Embodiments of the invention may provide a probabilistic update of data and/or lock contention meters, for example, for reducing cache line contention.

Embodiments of the invention may include a computer readable medium, such as for example a memory, a disk drive, or a “disk-on-key”, including instructions which when executed by a processor or controller, carry out methods disclosed herein.

While the invention has been described with respect to a limited number of embodiments, it will be appreciated that many variations, modifications and other applications of the invention may be made. Embodiments of the present invention may include other apparatuses for performing the operations herein. The appended claims are intended to cover all such modifications and changes.

What is claimed is:

1. A method comprising:
in a computing apparatus, comparing a measure of data contention for a group of operations protected by a lock to a predetermined threshold for data contention, and comparing a measure of lock contention for the group of operations to a predetermined threshold for lock contention;
eliding the lock for concurrently executing a plurality of operations of the group using a plurality of threads when the measure of data contention is approximately less than or equal to the predetermined threshold for data contention and the measure of lock contention is approximately greater than or equal to a predetermined threshold for lock contention; and
otherwise, acquiring the lock.

2. The method of claim 1, further comprising executing the group of operations.

3. The method of claim 1, wherein acquiring the lock comprises executing a plurality of operations of the group in a serialized manner when the measure of data contention is approximately greater than or equal to the predetermined threshold for data contention and the measure of lock contention is approximately less than or equal to a predetermined threshold for lock contention

4. The method of claim 1, wherein the predetermined thresholds for data and lock contention include measures of data and lock contention, respectively, for the group of operations detected during a past execution of the group.

5. The method of claim 1, wherein the measure is recorded using exponentially decaying counters.

6. The method of claim 1, wherein the measure is stored as a counter value in cache resident transactional memory.

7. The method of claim 1, further comprising periodically overriding the comparison and acquiring the lock for executing the plurality of operations of the group in a serialized manner.

8. The method of claim 1, further comprising periodically overriding the comparison and eliding the lock for concurrently executing the plurality of operations.

9. The method of claim 1, wherein eliding the lock is executed by a speculative lock elision mechanism.

10. The method of claim 1, wherein the plurality of threads concurrently execute the plurality of operations of the group using cache resident transactional memory.

11. An apparatus comprising:
a memory to store a predetermined thresholds for data contention and a predetermined thresholds for lock; and
a processor to compare a measure of data contention for a group of operations protected by a lock to the predetermined threshold for data contention, and compare a measure of lock contention for the group of operations to the predetermined thresholds for lock contention, elide the lock for concurrently executing a plurality of operations of the group using a plurality of threads when the measure of data contention is approximately less than or equal to the predetermined threshold for data contention and the measure of lock contention is approximately greater than or equal to a predetermined threshold for lock contention, and acquire the lock for executing a plurality of operations of the group in a serialized manner when the measure of data contention is approximately greater than or equal to the predetermined threshold for data contention and the measure of lock contention is approximately less than or equal to a predetermined threshold for lock contention.

12. The apparatus of claim 11, wherein the predetermined thresholds for data and lock contention include measures of data and lock contention, respectively, for the group of operations detected by the processor during a past execution of the group by the processor.

13. The apparatus of claim 11, wherein the predetermined thresholds are stored using exponentially decaying counters.

14. The apparatus of claim 11, wherein the memory includes cache resident transactional memory to store the measures of data and lock contention as a counter value.

15. The apparatus of claim 11, wherein the processor periodically overrides the comparison, acquires the lock, and executes the plurality of operations of the group in a serialized manner.

16. The apparatus of claim 11, wherein the processor periodically overrides the comparison, elides the lock, and concurrently executes the plurality of operations.
